(19) United States
(12) Patent Application Publication
(10) Pub. No.: US 2009/0263762 A1
(43) Pub. Date: Oct. 22, 2009

(54) DENTURE ABUTMENT & RETENTION SYSTEM

(76) Inventor: John S. Shepard, Fort Collins, CO (US)

Correspondence Address: ANCEL W. LEWIS, JR., 425 WEST MULBERRY, SUITE 101, FORT COLLINS, CO, 80521, US

(21) Appl. No.: 12/207,679

(22) Filed: Sep. 10, 2008

Related U.S. Application Data
(63) Continuation-in-part of application No. 12/103,847, filed on Apr. 16, 2008.

(51) Int. Cl. A61C 8/00

(52) U.S. Cl. 433/174

(57) ABSTRACT

A denture retention system includes a denture and an abutment. The denture has an inner channel with an elastic liner having shaped cavities. The cavities have a shaft, a head at the closed end of the shaft and a concave ring between two convex sections on the shaft. The abutment has a shaft, a head at one end of the shaft, a protruding ring between two concave sections on the shaft and a threaded portion at the other end of the shaft portion. The surface of the cavity overlaps and engages the surface of the abutment to retain the denture in the cavity. The threaded part of the abutment threads into an implant or implants into a jaw. The cavity expands when the abutment is inserted or removed from the cavity, and contracts after insertion.

This application is a continuation-in-part of Ser. No. 12/103,847 filed Apr. 16, 2008.

### TECHNICAL FIELD

The present invention relates to dentistry and more particularly to an abutment and system for releasably locating, supporting and retaining a denture.

### BACKGROUND ART

Dental implants are used to support one or more artificial teeth. Implants can help support, stabilize and retain full dentures. Suction aids retention of upper full dentures, but suction is generally inadequate for retention of lower full dentures.

Some prior known implants systems for dentures use a ball shaped abutment that projects from each implant. U.S. Pat. No. 4,787,851 to Kusano, et al. discloses a denture having an inner channel with an elastomeric liner and ball shaped abutments that project into the liner. U.S. Pat. No. 2,112,007 to Adams discloses a denture having an inner channel with snap ring cup sockets and ball shaped abutments that project into the sockets. U.S. Pat. No. 5,049,072 to Lueschen discloses a denture having an inner channel with sockets, O-rings and ball shaped abutments that project into the sockets.

Other prior known implants systems for dentures use two or more implants with abutments and a bar connecting the abutments. U.S. Pat. No. 5,678,997 to De Buck discloses abutments and a bar connecting the abutments, and a plastic rider connected to a denture that snaps onto the bar.

### DISCLOSURE OF THE INVENTION

A denture retention system includes a denture and at least two abutments. The denture has an inner channel with an elastic liner. The abutment has an abutment shaft portion with spaced first and second ends, an abutment head portion at the first end of the abutment shaft portion, a protruding portion between the abutment head portion and the second end of the abutment shaft portion and a threaded portion that projects from the second end of the abutment shaft portion. The abutment shaft portion has first and second concave sections on opposite sides of the abutment protruding portion. A peripheral surface on the abutment head portion has a plurality of flats for engaging a tool to insert the abutment. The abutment head portion has a smooth, convex end surface. The threaded portion can be sized and shaped to thread into an implant or to thread directly into bone as an implant. The liner of the denture has a denture cavity for each abutment. The cavity has a shape complimentary to the shape of the abutment with a cavity shaft portion, a cavity head portion and cavity protruding portion. The cavity surfaces overlap and engage the abutment surfaces to retain the abutment in the cavity. The denture cavity deforms to receive the abutment head portion and the abutment protruding portion.

### BRIEF DESCRIPTION OF THE DRAWINGS

Details of this invention are described in connection with the accompanying drawings that bear similar reference numerals in which:

FIG. 1 is a top plan view of a denture retaining system embodying features of the present invention.

FIG. 2 is a bottom plan view of a denture of the system of FIG. 1.

FIG. 3 is a sectional view of the system of FIG. 1 taken along line 3-3.

FIG. 4 is a side elevation view of an abutment of the system of FIG. 1.

FIG. 5 is a top plan view of the abutment of FIG. 4.

FIG. 6 is a bottom plan view of the abutment of FIG. 4.

FIG. 7 is a side elevation view of an implant for the abutment of FIG. 4.

FIG. 8 is a top plan view of the implant of FIG. 7.

FIG. 9 is a side elevation view of another abutment of the system of FIG. 1.

FIG. 10 is a side elevation view of a tool for insertion of the abutment of FIG. 4 or 9.

FIG. 11 is a top plan view of the tool of FIG. 10.

FIG. 12 is a bottom plan view of the tool of FIG. 10.

FIG. 13 is a sectional view of the system of FIG. 1 taken along line 3-3, with another cavity and another abutment.

FIG. 14 is a side elevation view of the abutment of FIG. 13.

FIG. 15 is a top plan view of the abutment of FIG. 14.

FIG. 16 is a bottom plan view of the abutment of FIG. 14.

FIG. 17 is a side elevation view of another abutment of the system of FIG. 1.

### DETAILED DESCRIPTION OF THE INVENTION

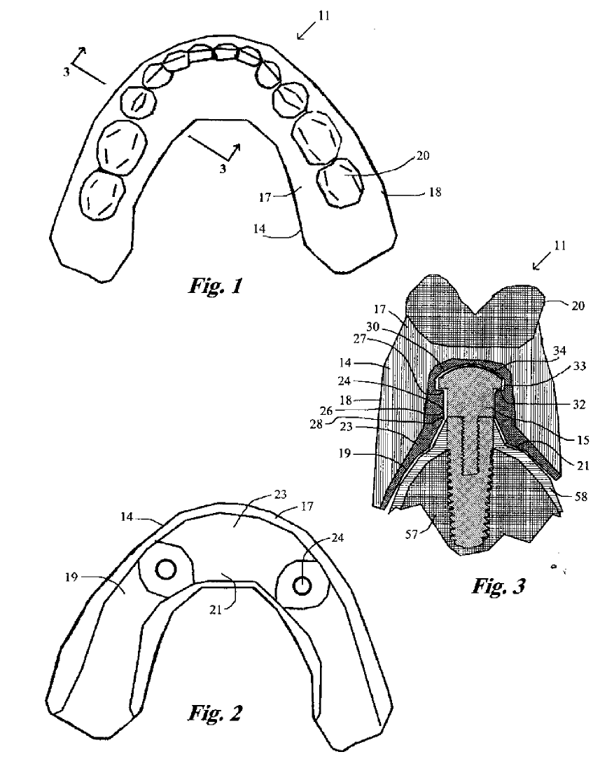

Referring now to FIGS. 1 to 3, a denture retention system 11 includes a denture 14 and abutments 15. The denture 14 has a body 17 with an outer side 18 and a spaced inner side 19. The outer side 18 is shaped to simulate the appearance of gums and a plurality of artificial teeth 20 are mounted on the outer side 18. The inner side 19 has an inner channel 21 that is shaped to receive the gums of a patient. The inner channel 21 includes an elastic liner 23. The liner is made of an elastomer, a natural or synthetic elastic material. The liner is preferably made of a medical silicone. By way of example, and not as a limitation, the liner 23 can be made of Silastic Type A by Dow-Corning.

The liner 23 includes a plurality of spaced, shaped denture cavities 24 that extend inwardly from the inner side 19 toward the outer side 18 of the body 17. The denture cavities 24 are substantially symmetrically positioned relative to the body 17 of the denture 14 and generally two or four denture cavities 24 are provided. Each denture cavity 24 has a cavity shaft portion 26 with spaced first and second ends 27 and 28, and a cavity head portion 30 at the first end 27 of the cavity shaft portion 26. The cavity shaft portion 26 is substantially cylindrical. The second end 28 of the cavity shaft portion 26 opens in the direction away from the outer side 18 of the body 17 of the denture 14.

The cavity head portion 30 extends radially outwardly relative to the cavity shaft portion 26, and has a ledge surface 32, a peripheral surface 33 and an end surface 34. The ledge surface 32 extends transversely, radially outwardly from the first end 27 of the cavity shaft portion 26. The peripheral surface 33 extends transversely from the periphery of the ledge surface 32 to the periphery of the end surface 34. The end surface 34 is preferably concave with a smooth, uninterrupted, low profile dome shape.

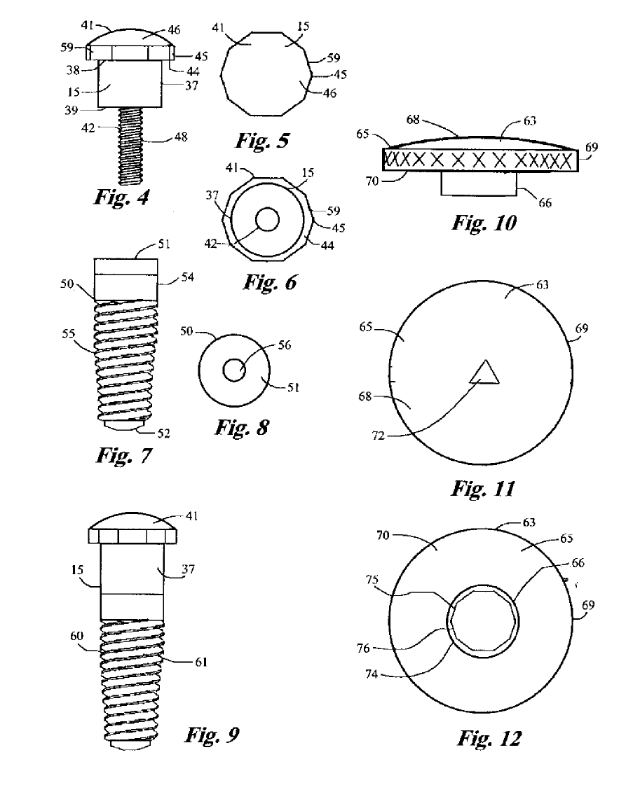

As shown in FIGS. 4 to 6, the abutment 15 includes an abutment shaft portion 37 with spaced first and second ends 38 and 39, an abutment head portion 41 attached to the first end 38 and a threaded portion 42 attached to the second end 39. The abutment shaft portion 37 is substantially cylindrical and the abutment head portion 41 projects radially outwardly relative to the abutment shaft portion 37. The abutment head portion 41 has an undercut surface 44 that extends transversely, radially outwardly from the first end 38 of the abutment shaft portion 37, a peripheral surface 45 that extends transversely from the periphery of the undercut surface 44, and an end surface 46, spaced from the undercut surface 44, that extends radially inwardly from the peripheral surface 45. The threaded portion 42 is cylindrical with external threads 48 and projects axially from the second end 39 of the abutment shaft portion 37.

FIGS. 7 and 8 show an implant 50 having spaced first and second ends 51 and 52. The first end 51 is flat. The implant 50 has a smooth, cylindrical surface 54 adjacent to the first end 51 and external threads 55 from the cylindrical surface 54 to the second end 52. A threaded aperture 56 extends into the implant 50 from the first end 51. The aperture 56 is sized and shaped to receive the threaded portion 42 of the abutment 15.

Referring again to FIG. 3, the cavity shaft portion 26 is sized to snugly fit around the abutment shaft portion 37, and the cavity head portion 30 is sized to snugly fit around the abutment head portion 41. Preferably the liner 23 of the denture 14 is molded around the abutment shaft portion 37 and the abutment head portion 41 of the abutments 15 so the cavity is of a complementary shape with the shape of the head and shaft portions of the abutment. The ledge surface 32 of the cavity head portion 30 retains the undercut surface 44 of the abutment head portion 41. The elastic liner 23 of the denture 14 stretches to allow removal of the abutments 15 and returns to the original shape after removal. The convex shape of the end surface 46 of the abutment head portion 41 spreads the second end 28 of the cavity shaft portion 26 and aids insertion of the abutment 15 into the denture cavity 24.

The threads 55 of the implant 50 thread into the jaw bone structure 57. The gums 58 extend above the jaw bone structure 57. The length of abutment shaft portion 37 varies depending upon the height of the gums 58 above the jaw bone structure 57.

As shown in FIGS. 4 to 6, the peripheral surface 45 of the abutment head portion 41 includes a plurality of flats 59, for engagement with an insertion tool, described hereinafter. Preferably the peripheral surface 45 of the abutment head portion 41 includes ten to twelve flats 59 instead of the four or six flats on square or hexagon headed bolts. The larger number of flats 59 more closely approximates a circular shape and reduces the possible misalignment of the denture 14 due to misalignment of the peripheral surface 33 of the cavity head portion 30 relative to the peripheral surface 45 of the abutment head portion 41.

FIG. 9 shows a modification to the abutment 15 having a threaded portion 60 with external threads 61. The threaded portion 60 is sized and shaped to thread directly into bone as an implant, replacing the implant 50 described above. This modification is an integral or a one piece body so the abutment and implant is a single piece.

Referring to FIGS. 10 to 12, an insertion tool 63 has a tool head portion 65 and an engagement portion 66. The tool head portion 65 has the shape of a disk with a round, convex top surface 68, a knurled peripheral surface 69 that extends transversely from the periphery of the top surface 68 and a flat bottom surface 70 that is spaced from the top surface 68. A tool aperture 72, sized and shaped to receive a torque tool, extends into the tool head portion 65 from the center of the top surface 68. The tool aperture 72 shown has triangular shape. The tool aperture 72 can have other shapes, such as hexagonal to receive an allen wrench or star shaped to receive a torque wrench. The tool 63 may have a hole to receive a string like dental floss that is tied thereto so the tool is not swallowed.

The engagement portion 66 is a wall that projects from the center of the bottom surface 70 of the tool head portion 65, and has a circular outer surface 74 and a radially inwardly spaced inner surface 75. The inner surface 75 has a plurality of flats 76. The inner surface 75 is sized and shaped to receive and engage the flats 59 of the peripheral surface 45 of the abutment head portion 41 of the abutment 15. The insertion tool 63 facilitates tightening of the abutment 15.

The system 11 provides improved retention over prior known systems without the use of a rigid cup in the denture. Although the system 11 described is directed towards retention of dentures, the abutment 15 can also be used for retention of facial prostheses such as a nose or ear.

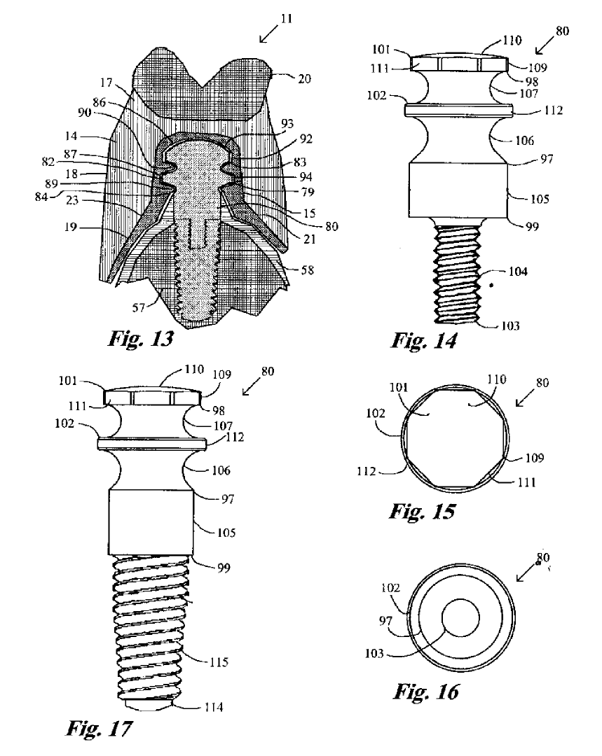

FIG. 13 shows another cavity 79 and another abutment 80 for the denture retention system 11. The cavity 79 has a cavity shaft portion 82 with a first end 83, a spaced, open second end 84, a cavity head portion 86 at the first end 83 of the cavity shaft portion 82, and a cavity protruding portion 87 on the cavity shaft portion 82 intermediate the cavity head portion 86 and the second end 84. The cavity head portion 86 and the cavity protruding portion 87 extend radially outwardly relative to the cavity shaft portion 82.

The cavity shaft portion 82 has a first convex section 89 between the cavity protruding portion 87 and the second end 84, and a second convex section 90 between the cavity head portion 86 and cavity protruding portion 87. The cavity head portion 86 has a peripheral surface 92 and an end surface 93 that connects to the peripheral surface 92 opposite the cavity shaft portion 82. The end surface 93 is preferably concave with a smooth, uninterrupted, low profile dome shape. The cavity protruding portion 87 has a peripheral surface 94.

Referring to FIGS. 13 to 16, the abutment 80 includes an abutment shaft portion 97 with spaced first and second ends 98 and 99, an abutment head portion 101 attached to the first end 98, an abutment protruding portion 102 intermediate the abutment head portion 101 and the second end 99, and a threaded portion 103 attached to the second end 99. The abutment head portion 101 and the abutment protruding portion 102 project radially outwardly relative to the abutment shaft portion 97. The threaded portion 103 is cylindrical with external threads 104 and projects axially from the second end 99 of the abutment shaft portion 97.

The abutment shaft portion 97 has a cylindrical section 105, first convex section 106 and a second convex section 107. The cylindrical section 105 extends from the second end 99. The first convex section 106 curves radially inwardly from the cylindrical section 105 and from the abutment protruding portion 102, and connects the abutment protruding portion 102 to the cylindrical section 105. The second convex section 107 curves radially inwardly from the abutment protruding portion 102 and from the abutment head portion 101, and connects the abutment protruding portion 102 and the abutment head portion 101. The length of the cylindrical section 105 of the abutment shaft portion 97 varies depending upon the height of the gums 58 above the jaw bone structure 57.

The abutment head portion 101 has a peripheral surface 109 and a smooth, convex end surface 110 that extends radially inwardly from the peripheral surface 109. The peripheral surface 109 of the abutment head portion 101 includes a plurality of flats 111 for engagement by the tool 63. The peripheral surface 109 of the abutment head portion 101 shown has eight flats. The abutment protruding portion 102 has a substantially cylindrical peripheral surface 112.

The cavity head portion 86 is sized to snugly fit around the abutment head portion 101, and the cavity protruding portion 87 is sized to snugly fit around the abutment protruding portion 102. The first and second convex sections 89 and 90 of the cavity shaft portion 82 are sized to snugly fit into the first and second concave sections 106 and 107 of the abutment shaft portion 97. The cavity head portion 86, cavity protruding portion 87, the first convex section 89 and the second convex section 90 engage the abutment 80 to retain the abutment 80 in the cavity 79. The elastic liner 23 of the denture 14 stretches to allow removal of the abutments 80 and returns to the original shape after removal. The convex shape of the end surface 110 of the abutment head portion 101 spreads the second end 84 of the cavity shaft portion 82 and aids insertion of the abutment 80 into the denture cavity 79.

The threaded portion 103 of the abutment 80 shown in FIGS. 13 to 16 is sized to thread into the implant 50 shown in FIGS. 7 and 8. FIG. 17 shows a modification to the abutment 80 having a threaded portion 114 with external threads 115. The threaded portion 114 is sized and shaped to thread directly into bone as an implant, replacing the implant 50 described above. This modification is an integral or a one piece body so the abutment and implant is a single piece.

Although the present invention has been described with a certain degree of particularity, it is understood that the present disclosure has been made by way of example and that changes in details of structure may be made without departing from the spirit thereof.

What is claimed is:

1. An abutment for retaining a denture having an elastic liner with a cavity having a complementary shape, comprising:
an abutment shaft portion having a first end and a spaced second end,
an abutment head portion attached to said first end of said abutment shaft portion and projecting radially outwardly relative to said abutment shaft portion, said abutment head portion having a peripheral surface and a smooth end surface transverse to and connected to said peripheral surface for insertion into said cavity in said denture,
an abutment protruding portion attached to and projecting radially outwardly from said abutment shaft portion between said first end and said second end, said abutment protruding portion being spaced from said abutment head portion, and
a threaded portion projecting from said second end of said abutment shaft portion and having external threads.

2. The abutment as set forth in claim 1 wherein said abutment shaft portion includes a cylindrical section extending from said second end, a first concave section connecting said cylindrical section to said abutment protruding portion and a second concave section connecting said abutment protruding portion to said abutment head portion.

3. The abutment as set forth in claim 2 wherein said first concave section of said abutment shaft portion curves radially inwardly from said cylindrical section and from said abutment protruding portion, and said second concave section of said abutment shaft portion curves radially inwardly from said abutment protruding portion and from said abutment head portion.

4. The abutment as set forth in claim 1 wherein said abutment protruding portion has a cylindrical peripheral surface.

5. The abutment as set forth in claim 1 wherein said threaded portion is sized to thread into an implant in a jaw.

6. The abutment as set forth in claim 1 wherein said threaded portion is sized to thread into a jaw bone structure as an implant.

7. The abutment as set forth in claim 1 wherein said peripheral surface includes a plurality of flats positioned to receive a tool to turn said abutment head portion.

8. The abutment as set forth in claim 7 wherein said peripheral surface has eight said flats.

9. The abutment as set forth in claim 1 wherein said end surface of said abutment head portion is convex to locate and center said abutment head portion upon insertion into said cavity in said elastic liner of said denture and to spread said cavity in said elastic liner of said denture upon insertion.

10. An abutment for retaining a denture comprising:
an abutment shaft portion having a first end, a spaced second end, a cylindrical section that extends from said second end, first concave section that extends from said cylindrical section and a second concave section between said first concave section and said first end,
an abutment head portion attached to said first end of said abutment shaft portion, connected to said second concave section and projecting radially outwardly relative to said cylindrical section of said abutment shaft portion, said abutment head portion having a peripheral surface that extends transverse to said second concave section and a smooth convex end surface opposite and spaced from said second concave surface, said end surface being transverse to and connected to said peripheral surface, said peripheral surface having eight flats positioned to receive a tool to turn said abutment head portion,
an abutment protruding portion between said first and second concave sections and attached to said first and second concave sections, said protruding portion projecting radially outwardly relative to said cylindrical section of said abutment shaft portion, said abutment protruding portion being spaced from said abutment head portion, and
a threaded portion projecting from said second end of said abutment shaft portion and having external threads, said threaded portion being sized to thread into an implant in a jaw.

11. A denture retaining system comprising:
a denture having an outer side with a plurality of artificial teeth and an inner side having an inner channel with an elastic liner, said liner including at least one shaped denture cavity, said denture cavity having a cavity shaft portion with a first end, a spaced, open second end, a cavity head portion at said first end of said cavity shaft portion, and a cavity protruding portion between said cavity head portion and said second end, said cavity head portion and said cavity protruding portion projecting radially outwardly relative to said cavity shaft portion, and
an abutment for each said cavity, said abutment having an abutment shaft portion with a first end and a spaced second end, an abutment head portion attached to said first end of said abutment shaft portion and projecting radially outwardly relative to said abutment shaft portion, an abutment protruding portion attached to and projecting radially outwardly from said abutment shaft portion between said first end and said second end, and a threaded portion projecting from said second end of said abutment shaft portion, said abutment head portion being sized to extend radially outwardly relative to said cavity shaft portion, said abutment protruding portion being sized to extend radially outwardly relative to said cavity shaft portion,
whereby said abutment head portion and said cavity head portion engage one another and said abutment protruding portion and said cavity protruding portion engage one another, to retain said denture relative to said abutment.

12. The system as set forth in claim 11 wherein:
said cavity shaft portion has a first convex section between said cavity protruding portion and said second end and a second convex section between said cavity head portion and said cavity protruding portion, and
said abutment shaft portion has a first concave section between said abutment protruding portion and said second end and a second concave section between said abutment head portion and said abutment protruding portion, said first concave section being sized to receive said first convex section of said cavity shaft portion and said second concave section being sized to receive said second convex section of said cavity shaft portion,
whereby said first concave section and said first convex section engage one another and said second concave section and said second convex section engage one another to retain said denture relative to said abutment.

13. The system as set forth in claim 11 wherein said first concave section of said abutment shaft portion curves radially inwardly from said cylindrical section and from said abutment protruding portion, and said second concave section of said abutment shaft portion curves radially inwardly from said abutment protruding portion and from said abutment head portion.

14. The abutment as set forth in claim 11 wherein said abutment protruding portion has a cylindrical peripheral surface.

15. The system as set forth in claim 11:
including an implant having a first end, a spaced second end, external threads between said first and second ends, and a threaded implant aperture extending into said implant from said first end, said external threads being sized and shaped to implant into a jaw, and
wherein said threaded portion of said abutment is sized and shaped to thread into said implant aperture.

16. The system as set forth in claim 11 wherein said threaded portion of said abutment is sized and shaped to implant into a jaw.

17. The system as set forth in claim 11 wherein said abutment head portion includes a peripheral surface having a plurality of flats.

18. The system as set forth in claim 17 wherein said peripheral surface has eight flats.

19. The system as set forth in claim 17 including an insertion tool having an engagement portion with an inner surface, said inner surface having a plurality of flats and being sized and shaped to engage said flats on said peripheral surface of said abutment head portion to turn said abutment.

20. The system as set forth in claim 19 wherein insertion tool has a tool head portion with a top surface opposite said engagement portion and a tool aperture extending into said tool head portion from said top surface, said tool aperture being sized and shaped to receive a torque imparting tool.

21. The system as set forth in claim 20 wherein said tool aperture is triangular.

22. The system as set forth in claim 11 wherein said abutment head portion has a convex end surface opposite and spaced from said undercut surface.

23. The system as set forth in claim 11 wherein said liner is made of medical silicone.

24. A denture retaining system comprising:
a denture having an outer side with a plurality of artificial teeth and an inner side having an inner channel with a liner of medical silicone, said liner including at least one shaped denture cavity, said denture cavity having a cavity shaft portion with a first end and a spaced, open second end, a cavity head portion at said first end of said cavity shaft portion, and a cavity protruding portion between said cavity head portion and said second end, said cavity shaft portion having a first convex section between said cavity protruding portion and said second end, and a second convex section between said cavity head portion and said cavity protruding portion, said cavity head portion and said cavity protruding portion projecting radially outwardly relative to said cavity shaft portion,
an abutment for each said cavity, said abutment having an abutment shaft portion with a first end and a spaced second end, an abutment head portion attached to said first end of said abutment shaft portion and projecting radially outwardly relative to said abutment shaft portion, an abutment protruding portion attached to and projecting radially outwardly from said abutment shaft portion between said first end and said second end, and a threaded portion projecting from said second end of said abutment shaft portion, said abutment shaft portion having a first concave section between said abutment protruding portion and said second end and a second concave section between said abutment head portion and said abutment protruding portion, said abutment head portion being sized to extend radially outwardly relative to said cavity shaft portion, said abutment protruding portion being sized to extend radially outwardly relative to said cavity shaft portion, said first concave section being sized to receive said first convex section of said cavity shaft portion and said second concave section being sized to receive said second convex section of said cavity shaft portion, said abutment head portion having a peripheral surface and a smooth convex end surface transverse to and connected to said peripheral surface, said peripheral surface having eight flats,
an implant having a first end, a spaced second end, external threads between said first and second ends, and a threaded implant aperture extending into said implant from said first end, said external threads being sized and shaped to implant into a jaw, said implant aperture being sized and shaped to receive said threaded portion of said abutment, and
an insertion tool having a tool head portion and an engagement portion attached to said tool head portion, said tool head portion having a top surface opposite said engagement portion and a tool aperture extending into said tool head portion from said top surface, said tool aperture being sized and shaped to receive a torque imparting tool, said engagement portion having an inner surface, said inner surface having a plurality of flats and being sized and shaped to engage said flats on said peripheral surface of said abutment head portion to turn said abutment,
whereby said abutment head portion and said cavity head portion engage one another and said abutment protruding portion and said cavity protruding portion engage one another, to retain said denture relative to said abutment.
